(19) United States
(12) Patent Application Publication
(10) Pub. No.: US 2018/0371880 A1
(43) Pub. Date: Dec. 27, 2018

(54) Slotted liner with optimal slot configuration

(71) Applicant: RGL RESERVOIR MANAGEMENT INC., Calgary (CA)

(72) Inventors: Brent Daniel Fermaniuk, Sherwood Park (CA); Kelly Julien Rondeau, Edmonton (CA); Michael Clarence Claerhout, Beaumont (CA)

(21) Appl. No.: 16/062,588

(22) PCT Filed: Dec. 16, 2016
(86) PCT No.: PCT/CA2016/051501

§ 371 Date: Jun. 14, 2018

Related U.S. Application Data
(60) Provisional application No. 62/269,819, filed on Dec. 18, 2015.

(51) Int. Cl. E21B 43/08

(52) U.S. Cl. CPC E21B 43/086; B01D 29/33; B01D 2201/184

(57) ABSTRACT

A slotted liner comprises a pipe having a plurality of slots extending through the pipe wall. The slots are arranged in clusters provided along the length of the pipe. In one aspect, the clusters are generally elliptical in shape.

### FIELD OF DISCLOSURE

The disclosure describes generally a slotted liner for use in hydrocarbon extraction processes. More particularly, described herein is a liner having an optimized configuration of slots.

### BACKGROUND OF DISCLOSURE

In operations for recovering hydrocarbons, such as oil and gas, from subterranean formations, it is common to use a pipe, namely a casing or liner, which is installed in a well bore. Hydrocarbons contained in an underground formation are produced by means of such liners. Generally, a liner is preferably perforated or slotted with multiple slots about its circumference before placement in the well bore. Such a pipe is referred to as a slotted liner. Slotted liners serve to allow the desired hydrocarbon materials in the formation to enter the pipe, while restricting or filtering out debris, particulate matter or other such contaminants contained in the formation. The filtered hydrocarbon materials are thereby produced, or delivered to the surface for subsequent processing. Slotted liners are taught, for example, in U.S. Pat. Nos. 1,620,412 and 4,343,359.

Various improvements have been proposed to increase the efficiency of slotted liners. Generally, such improvements have focussed on the dimensions of the slots provided on the liner. Examples of such improvements in slot dimensions are provided in PCT publication number WO 2014/179856 and U.S. Pat. No. 6,543,539.

Similarly, other efforts have been made to improving the slotting geometry of liners. An example of such slot geometry is provided in U.S. Pat. No. 6,904,974, wherein slots are provided in a helical form, which allows the outer diameter of certain sections of the liner to be expanded or contracted.

There exists a need for a slotted liner having an improved slot configuration.

### SUMMARY OF THE DESCRIPTION

The present description provides a slotted liner having an optimized slot configuration that allows a desired amount of open area to allow flow of fluid there-through, while maintaining the desired filtering and structural strength characteristics.

In one aspect, there is provided a slotted liner comprising a pipe having a wall and a longitudinal axis, the pipe further comprising a plurality of slots extending through the wall and providing a plurality of communication channels for fluid communication between the exterior and interior of the pipe, the slots being arranged in clusters, wherein each of the clusters has a generally elliptical shape having a major axis and a minor axis, and wherein the major axes of each of the clusters is generally parallel with the longitudinal axis of the pipe.

In one aspect, the slots of each cluster are arranged parallel with the longitudinal axis of the pipe.

In another aspect, the slots of each cluster are arranged in a radiating manner, wherein the slots of each cluster converge at the center of the cluster

### BRIEF DESCRIPTION OF THE DRAWINGS

The features of certain embodiments will become more apparent in the following detailed description in which reference is made to the appended figures wherein:

FIG. 1 is a schematic illustration of a slotted liner as known in the art.

FIG. 2 is a schematic illustration of a slotted liner according to an aspect of the present description.

FIG. 3 is a schematic illustration of a slotted liner according to another aspect of the present description.

FIG. 4 is a partial side elevation view of the slotted liner of FIG. 2.

FIGS. 5 to 8 are partial side elevation views of other aspects of the slotted liner according to the present description.

### DETAILED DESCRIPTION

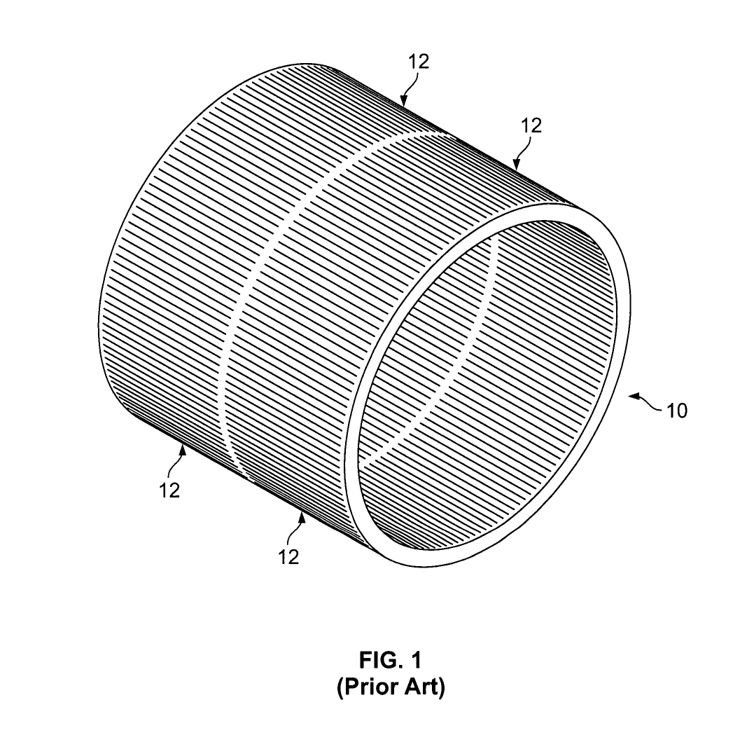

FIG. 1 illustrates a section of a slotted liner 10 as known in the art. As shown, the liner 10 includes a plurality of slots 12, which extend through the wall of the liner. In this manner, and as would be known to persons skilled in the art, the slots 12 allow passage of fluids from the exterior of the liner into the interior thereof. The reverse flow can also be achieved if necessary.

As known in the art, the size of the slots 12 must be sufficient to allow passage of fluids, in particular hydrocarbon materials such as oil and gas etc., with a minimum amount of hindrance to flow. At the same time, the slots 12 must be sized so as to prevent passage of debris or other material present in the well or formation. In this way, the slotted liner filters out material that may be detrimental to the flow and/or downstream processing of the hydrocarbon materials being extracted from the formation.

As would be appreciated, in designing slotted liners, it is desired to increase the open area provided so as to maximize the flow of fluids into the liner. Increasing open area can be achieved by either increasing the dimensions of the slots or by providing more slots on the liner. As discussed above, any increase in slot dimensions is limited by the requirement of providing sufficient filtering efficiency. Further, increasing the open area of the liner must also be balanced with the resulting reduction in pipe strength or integrity. As known in the art, liners are typically subjected to at least torsional and axial stresses when in use. Thus, providing a liner with a large number of slots, while increasing open area and increasing fluid flow, may result in a liner that lacks the required structural strength. In addition, increasing the number of slots to increase the open area of a liner also involves additional production costs.

In the course of their research, the present inventors have found that providing the slots of a slotted liner in clusters allows for the desired amount of open area to be provided while retaining or improving the strength characteristics of the liner. In particular, the inventors have found that an optimized balance of open area and liner strength can be achieved by providing slots in clusters that are generally elliptical. The elliptical shaped cluster of slots allows for the size of the cluster to be adjusted along the two axes of the ellipse. This therefore allows the liner to be adjusted to meet desired or required characteristics depending on the contemplated use.

It should be noted that circular and/or oval shapes of slot clusters may also be provided. However, such shapes of clusters are not as preferred as the other arrangements described herein due to the limited ability of tailoring the strength and open area characteristics of the slotted liner.

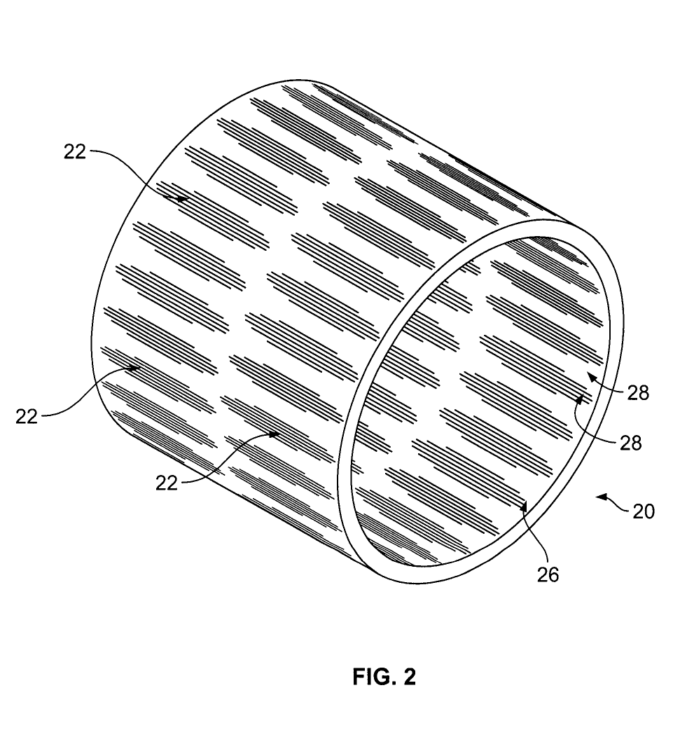

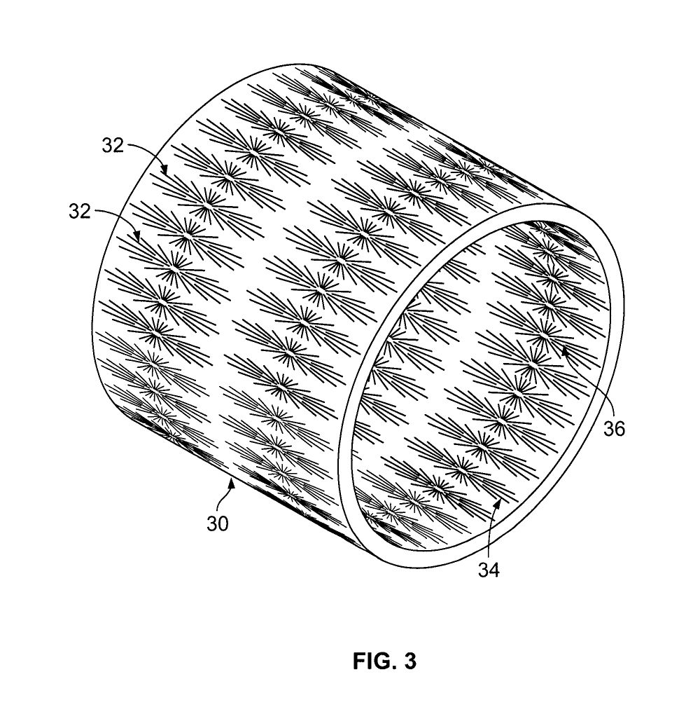

FIGS. 2 and 3 illustrate slotted liners according to two embodiments of the present description. As can be seen, each embodiment provides a liner having a plurality of slots arranged in a cluster format. In FIG. 2, the slotted liner 20 includes a plurality of clusters 22 of slots. The clusters 22 are preferably generally evenly spaced circumferentially and are aligned axially with the longitudinal axis of the liner. As shown in FIG. 2, the clusters 22 according to this embodiment are of a generally elliptical shape, having a major axis that is generally parallel with the longitudinal axis of the liner. In other embodiments, the cluster of slots may be aligned at an angle to the longitudinal axis of the liner. In this way, the torsional capacity of the liner may be tuned or adjusted as needed. In the embodiment shown in FIG. 2, the elliptically-shaped clusters are formed by providing slots of different lengths. As shown, the overall elliptical shape of the clusters 22 is formed by providing the longest slot or slots 24 at the center of the ellipse, along the major axis of the ellipse, while providing the shortest slots 28 at the ends of the minor axis of the ellipse. The slots in each cluster 22 are generally elongate and are arranged so as to be generally parallel with the major axis of the elliptical shape of the cluster. In the embodiment shown in FIG. 2, where the major axis of the elliptically shaped cluster 22 is aligned or parallel with the longitudinal axis of the liner, it is observed that the slots of the cluster are also generally aligned with the longitudinal axis of the liner. However, in other embodiments, where the cluster is angled with respect to the longitudinal axis of the liner, it will be understood that the slots of the cluster would also be similarly angled.

FIG. 3 illustrates another embodiment of the liner described herein. As shown, the slotted liner 30 includes a plurality of generally elliptically-shaped clusters 32 of slots. As with the embodiment shown in FIG. 2, the clusters 32 of slots are generally evenly spaced circumferentially and are generally aligned with the longitudinal axis of the liner 30. As will be understood, in other embodiments, the clusters may be aligned at an angle to the longitudinal axis of the liner, as discussed above. In the embodiment illustrated in FIG. 3, the slots are arranged in a generally star-shaped manner. Specifically, as shown in FIG. 3, the slots of a given cluster are arranged in a generally radiating manner originating at the center of the elliptical shape and radiating outwards. As will be understood, in this arrangement, the longer slots 34 are arranged to extend generally in the direction of the major axis of the ellipse, while the shorter slots 36 are arranged to extend generally in the direction of the minor axis of the ellipse. Other lengths of slots are provided between the longest and shortest slots and, as shown, radiate in directions between the major and minor axes of the ellipse. In other words, all of the slots of a given cluster 32 converge at the center of such elliptically-shaped cluster. In other embodiments, the slots of the ellipse may be arranged in two groups, wherein one group of slots converge at a first focal point of the ellipse while another group of slots converge at a second focal point of the ellipse.

While FIGS. 2 and 3 illustrate two embodiments of arranging slots in a generally elliptical shape, other slot arrangements will be understood as being encompassed by the present description. For example, an overall elliptical shape of slot clusters may be provided with the slots being of different shapes or angular orientation. Such a variety of slot arrangement is also contemplated for other cluster shapes, such as circular etc. In general, the slot orientation, the slot cluster arrangement and other features described above can be tailored as needed. However, the aforementioned elliptical cluster shapes have been so far found to have beneficial characteristics. In addition, the slots of each cluster may be provided at different spacings with respect to each other. For example, in a given elliptical cluster as shown in FIG. 2, some slots may be spaced further apart from others. In a given elliptical cluster as shown in FIG. 3, the slots may be provided at different angular separations. Further, in the present description, it has been assumed that a given cluster of slots includes a plurality of slots. However, it will be understood that the present description is not limited to the number of slots. That is, a cluster may have as few as three slots or as many slots as can be provided using current or future slot cutting technologies.

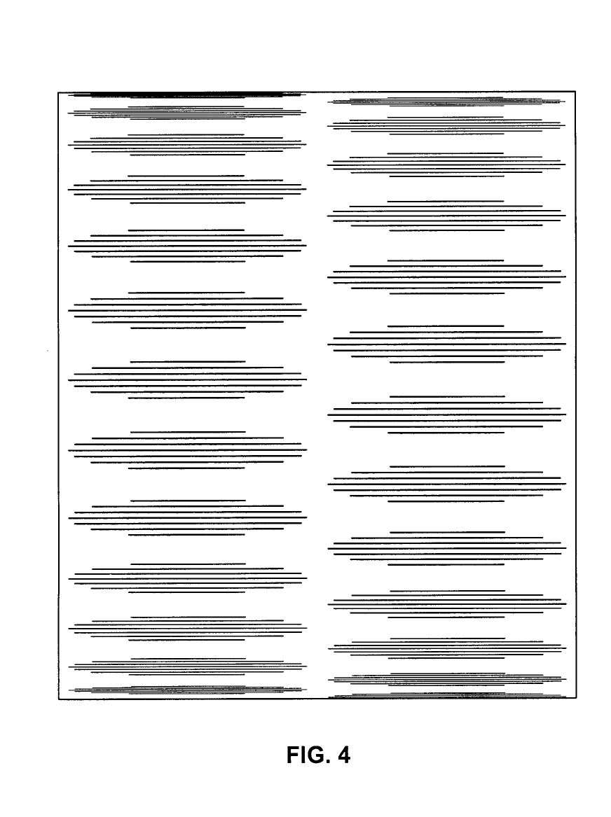

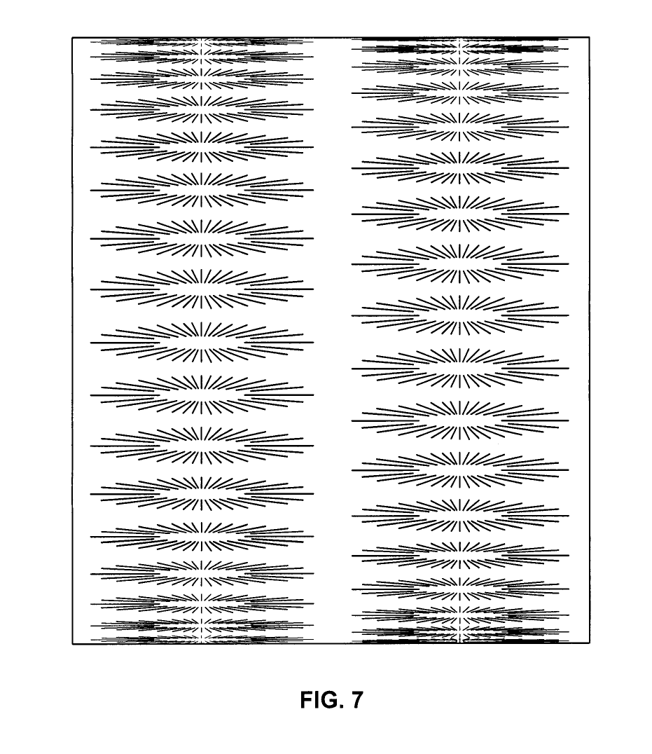

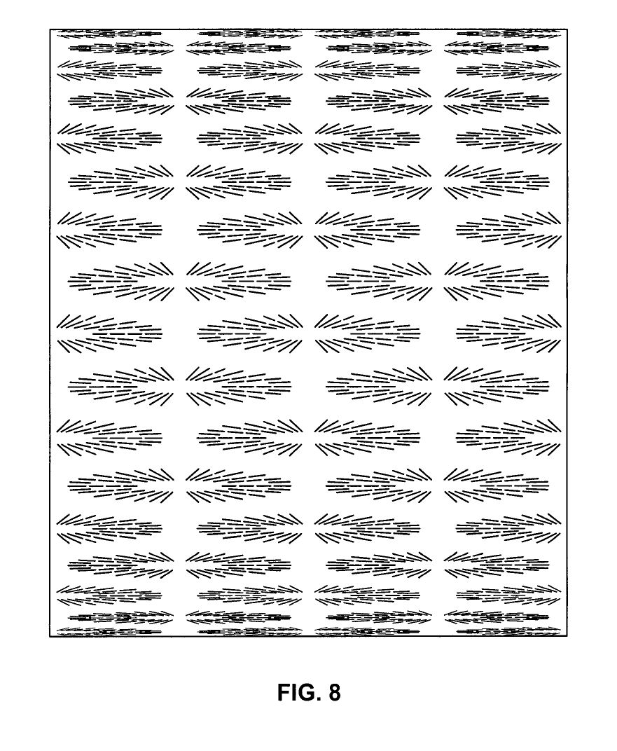

FIGS. 4 to 8 illustrate some further examples of slotted liners where clusters of slots are provided in other arrangements. FIG. 4 illustrates a partial side view of the slot clusters shown in FIG. 2. As noted in this example, the slot clusters are arranged circumferentially in a generally equidistant manner. In this orientation, circumferential rings of clusters are provided. As can be seen, according to this aspect, adjacent circumferential rings of clusters are offset from each other in the circumferential direction, whereby no two clusters are axially aligned.

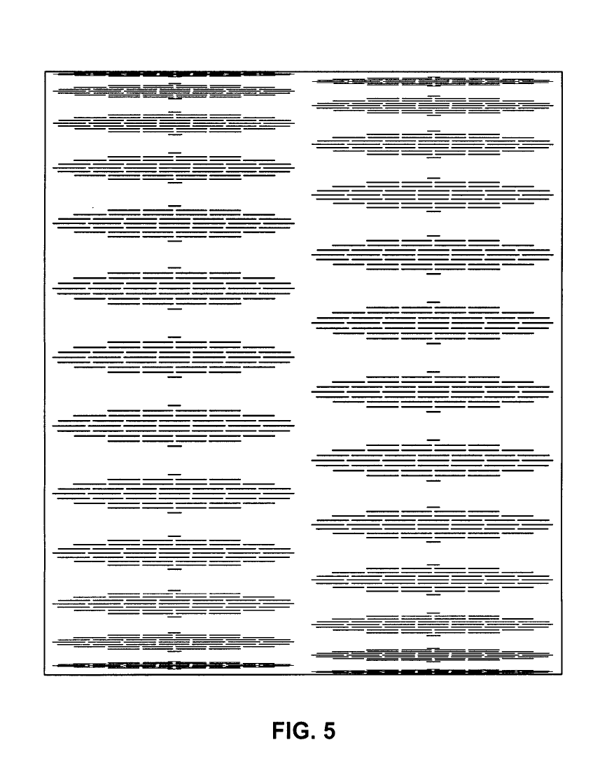

FIG. 5 is an example of slot arrangement similar to that shown in FIGS. 2 and 4, but where the slots are not continuous. As such, each of the slots are formed by a plurality of smaller slots.

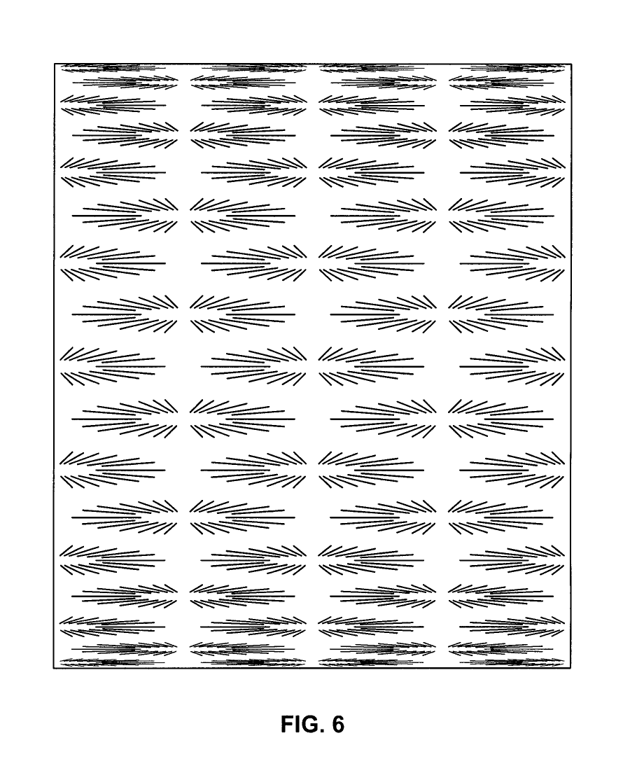

FIGS. 6 to 8 illustrate variations in the slot configuration shown in FIG. 3.

### Examples

The three sample slotted liners illustrated in FIGS. 1, 2 and 3 were subjected to a finite element analysis (FEA) to determine their strength characteristics when subjected to torsional loading. For each of the test samples, the open area of the liner was set to roughly 12% and the width of each slot was laser cut to roughly 0.020 inches. The results of the FEA analysis are provided in Table 1.

TABLE 1

| | | Torsional |
|---|---|---|
| | | Loading Limit |
| Sample | Description | (ft. lb.) |
| 1 (FIG. 1) | Evenly spaced rows of slots | 3550 |
| 2 (FIG. 2) | Elliptical clusters with axially aligned slots | 11000 |
| 3 (FIG. 3) | Elliptical clusters with radiating slots | 15000 |

“Torsional loading limit”, as recited in Table 1, was defined as the load applied to the liner to result in a permanent narrowing of the slot by 0.001 inch (i.e. after removal of the load).

Results

The test results clearly illustrated that the elliptical cluster pattern of slots provided a significant improvement of the strength characteristics of the pipe, at least as measured by the torsional loading limit, over the known liner having evenly spaced rows of slots.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description, but should be given the broadest interpretation consistent with the present specification as a whole. The disclosures of all prior art recited herein are incorporated herein by reference in their entirety.

1. A slotted liner comprising a pipe having a wall and a longitudinal axis, the pipe further comprising a plurality of slots extending through the wall thereby providing a plurality of communication channels for fluid communication between the exterior and interior of the pipe, wherein the slots are arranged in clusters.

2. The slotted liner of claim 1, wherein the clusters of slots are arranged generally equidistantly over the circumference of the pipe to form circumferential rings of clusters.

3. The slotted liner of claim 2, wherein adjacent rings of clusters are circumferentially offset, whereby adjacent clusters are not axially aligned.

4. The slotted liner of claim 1, wherein the clusters of slots are provided over the length of the pipe.

5. The slotted liner of claim 1, wherein each of the clusters has a generally elliptical shape having a major axis and a minor axis.

6. The slotted liner of claim 5, wherein the major axis of each of the clusters is generally parallel with the longitudinal axis of the pipe.

7. The slotted liner of claim 5, wherein the major axis of each of the clusters is angled with respect to the longitudinal axis of the pipe.

8. The slotted liner of claim 1, wherein each of the clusters has a generally circular shape.

9. The slotted liner of claim 1, wherein the slots of each cluster are generally parallel with the longitudinal axis of the pipe.

10. The slotted liner of claim 1, wherein the slots of each cluster are angled with respect to the longitudinal axis of the pipe.

11. The slotted liner claim 1, wherein the slots of each cluster are arranged in a radiating manner, wherein the slots of each cluster converge at the center of said cluster.

12. The slotted liner claim 1, wherein each cluster has a generally elliptical shape and the slots of each cluster are arranged in a radiating manner, wherein one group of the slots converge at a first focal point of the elliptical shape and another group of slots converge at a second focal point of the elliptical shape.

13. The slotted liner of claim 1, wherein the slots of each cluster are evenly spaced from each other.

14. The slotted liner of claim 1, wherein each cluster has at least three slots.

15. The slotted liner of claim 8, wherein the slots of each cluster are generally parallel with the longitudinal axis of the pipe.

16. The slotted liner of claim 8, wherein the slots of each cluster are angled with respect to the longitudinal axis of the pipe.

17. The slotted liner of claim 5, wherein the slots of each cluster are arranged in a radiating manner, wherein the slots of each cluster converge at the center of said cluster.

18. The slotted liner of claim 8, wherein the slots of each cluster are arranged in a radiating manner, wherein the slots of each cluster converge at the center of said cluster.

19. The slotted liner of claim 12, wherein the slots of each cluster are evenly spaced from each other.

20. The slotted liner of claim 12, wherein each cluster has at least three slots.

21. The slotted liner of claim 1, wherein the slots of each cluster are unevenly spaced from each other.

22. The slotted liner of claim 12, wherein the slots of each cluster are unevenly spaced from each other.

23. The slotted liner of claim 1, wherein each of the clusters has a generally oval shape.
